(19) United States
(12) Patent Application Publication
(10) Pub. No.: US 2017/0235881 A1
(43) Pub. Date: Aug. 17, 2017

(54) SYSTEM AND METHOD FOR THE DISTRIBUTION OF DIAGNOSTIC IMAGING

(71) Applicant: KONINKLIJKE PHILIPS N.V., EINDHOVEN (NL)

(72) Inventor: MERLIJN SEVENSTER, CHICAGO, IL (US)

(21) Appl. No.: 15/501,985

(22) PCT Filed: Aug. 10, 2015
(86) PCT No.: PCT/IB2015/056077

§ 371 Date: Feb. 6, 2017

Related U.S. Application Data
(60) Provisional application No. 62/036,134, filed on Aug. 12, 2014.

(51) Int. Cl. G06F 19/00; G06T 7/00

(52) U.S. Cl. CPC G06F 19/321; G06F 19/327; G06F 19/3443; G06T 7/0012; G06T 2207/30096

(57) ABSTRACT

A system and method for efficiently assigning an imaging study to be read. The system and method performing the steps of retrieving a current imaging study to be read, determining whether the current imaging study is for a patient whose lesion has been previously registered in a workflow tool, and assigning the current imaging study to a user based on at least one of a computed expected net gain for each user available to read the current imaging study and an expected utility gain for the current imaging study, the expected net gain based on whether each user utilizes the workflow tool.

### BACKGROUND

Radiological imaging provides critical phenotypical evidence for diagnosis and follow-up in oncology care. It has been recognized that generation of the quality of oncological imaging studies is an important component for diagnostics and treatment response assessments. Other components may include human factors, such as inter-reader and intra-reader interpretation variability, and efficiency. Clinical studies have shown that measurements of oncological lesions vary between readers (intra-reader variability) and between sessions, even if they are conducted by the same reader (inter-reader variability). For example, different readers may have different opinions regarding what pixels constitute the edge of a lesion and how it should be measured. Intra-reader variability has been found to be larger than inter-reader variability.

Guidelines have been proposed to objectify and standardize the treatment response assessment in cancer patients. Response Evaluation Criteria in Solid Tumors (RECIST) is the dominant guideline in this arena. For a given image study, it compares the sum of all tracked legions (in relevant axes) against the imaging study with a minimum sum. If the interval increase exceeds 20%, it is considered a progressed disease and treatment may be reconsidered. Intra-reader variability, however, is a source of variation that potentially affects guideline-based treatment response assessment. It has been shown that intra-reader variability may be large enough to influence patient care. For example, a physician or other user may erroneously continue treatment of a patient who has a progressed disease. Since intra-reader variability is generally larger than inter-reader variability, it has been recommended that the same reader (e.g., radiologist) should perform measurements for any one patient for the duration of the clinical trial. However, no system for efficiently routing individual imaging studies to the appropriate reader currently exists.

### SUMMARY OF THE INVENTION

A method for efficiently assigning an imaging study to be read. The method comprising retrieving a current imaging study to be read, determining whether the current imaging study is for a patient whose lesion has been previously registered in a workflow tool and assigning the current imaging study to a user based on at least one of a computed expected net gain for each user available to read the current imaging study and an expected utility gain for the current imaging study, the expected net gain based on whether each user utilizes the workflow tool.

A system for efficiently assigning an imaging study to be read. The system comprising a non-transitory computer readable storage medium storing an executable program and a processor executing the executable program to cause the processor to retrieve a current imaging study to be read, determine whether the current imaging study is for a patient whose lesion has been previously registered in a workflow tool, and assign the current imaging study to a user based on at least one of a computed expected net gain for each user available to read the current imaging study and an expected utility gain for the current imaging study, the expected net gain based on whether each user utilizes the workflow tool.

### BRIEF DESCRIPTION OF THE DRAWINGS

FIG. 1 shows a schematic drawing of a system according to an exemplary embodiment.

FIG. 2 shows a flow diagram of a method according to a first exemplary embodiment.

FIG. 3 shows a flow diagram of a method according to a second exemplary embodiment.

### DETAILED DESCRIPTION

The exemplary embodiments maybe further understood with reference to the following description and the appended drawings, wherein like elements are referred to with the same reference numerals. The exemplary embodiments relate to a system and method for routing an imaging study of a patient to a user (e.g., radiologist) to be read. In particular, the exemplary embodiments describe routing an imaging study based on whether the user has read prior imaging studies of the patient, whether the user is currently available to read the imaging study and/or whether there is a benefit for the user to read the imaging study. Although exemplary embodiments specifically describe routing radiological imaging studies for cancer patients, it will be understood by those of skill in the art that the system and method of the present disclosure may be used to route any study or exam requiring a reading to an appropriate user within any of a variety of hospital settings.

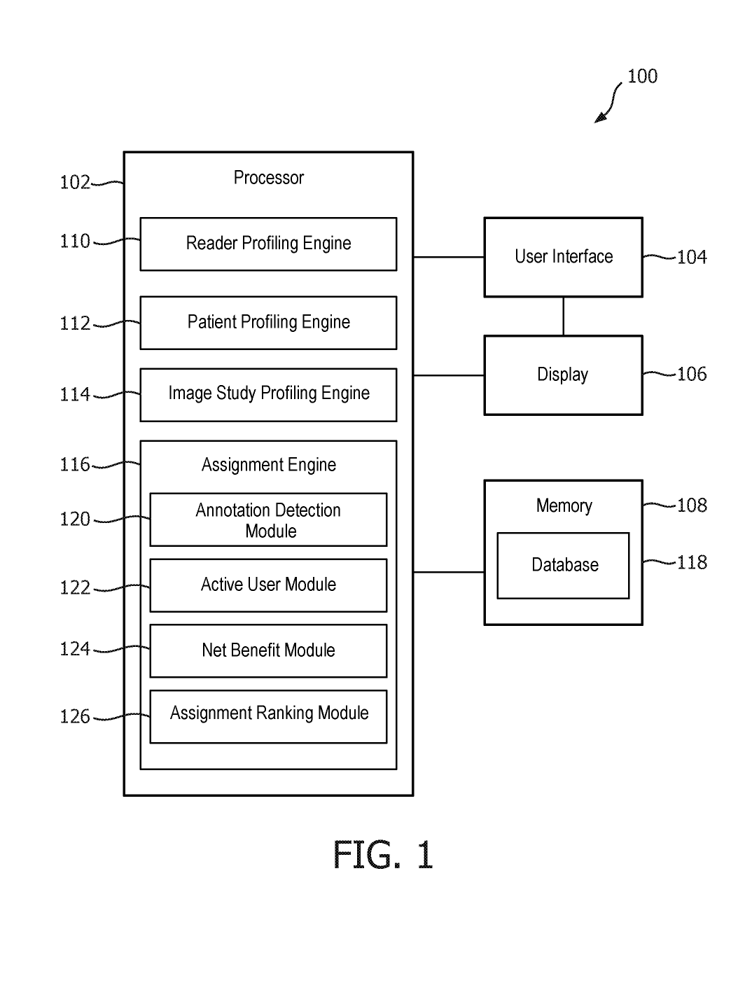

FIG. 1 shows a system 100 for routing an imaging study of a patient to a user according to an exemplary embodiment of the present disclosure. The system 100 comprises a processor 102, a user interface 104, a display 106 and a memory 108. The processor 102 profiles users (e.g., radiologists) and patients, storing profiled information relating which users have read which imaging studies of which patients in a database 118 of the memory 108. The processor 102 profiles a current imaging study to be read to determine whether the current imaging study relates to any prior studies of any of the patients in the database 118 to determine how the current imaging study should be assigned to a user. For example, if a current imaging study is a follow-up imaging study for a patient who is currently being treated, it may be most beneficial to assign the current imaging study to the same user who read the patient's prior imaging studies.

In a further example, some hospitals have begun to use workflow tools for tracking lesions identified in imaging studies of cancer patients so that radiologists may manage lesion measurements. These workflow tools may include adding meta data (e.g., annotations, image markups, etc.) to an imaging study. Reading follow-up imaging studies for lesions that have already been registered in the workflow tool may save a user time when reading the follow-up image study. Adding a new lesion to the workflow tool, however, takes time and not all radiologists choose to use these workflow tools. In one example, registering a new lesion to the workflow tool may cost a user 6 to 20 seconds of their time while reading an imaging study for a lesion that has already been registered in the workflow tool may save a user 3 to 10 seconds of time. Thus, the processor 102 may determine whether the current imaging study is for a lesion that has previously been registered in a workflow tool so that the current imaging study may be routed to a user who has read a prior imaging study for the same patient and/or to a user who prefers to use the workflow tool so that the current imaging study may be read in the most efficient manner possible.

The processor 102 includes a reader profiling engine 110, a patient profiling engine 112, an image study profiling engine 114 and an assignment engine 116. The reader profiling engine 110 determines for each patient with follow-up imaging studies, which user has read the prior most recent imaging study. The reader profiling engine 110 also determines which users use hospital workflow tools, which do not, and which may use workflow tools only if a lesion has already been registered.

The patient profiling engine 112 tracks whether a patient is under treatment for cancer and receives regular image study follow ups. This may be detected by identifying intervals between imaging studies. For example, if the interval is approximately 3 months (which is the generally accepted time interval between imaging studies for tracking a lesion) this may indicate that the patient is on cancer treatment. Cancer patients may also be identified via other identifying information (e.g., name) or via a role of a referring physician (e.g., oncologist). In another example, the patient profiling engine 112 may access a hospital's electronic records to determine whether the patient has had recurring appointments in the hospital's oncology department. Alternatively, a user may manually indicate whether the patient is receiving cancer care. The patient profiling engine 112 may also determine whether a patient's most recent imaging study has been stored in the workflow tool.

The image study profiling engine 114 determines whether the current imaging study is a follow-up imaging study for a patient that is currently being treated. The image study profiling engine 114 identifies a modality of the image (e.g., CT, MRI) and an anatomy (e.g., abdomen, brain) of the current imaging study to match the current imaging study to the modality and anatomy of prior studies. Other information such as patient identifying information, the role of a referring physician and information obtained from the patient health record may also be used. The image study profiling engine 114 may also determine whether the current imaging study relates to a lesion for a patient that has been registered in the hospital workflow tool.

The assignment engine 116 uses the profile information of the current imaging study along with profile information of patients and users to determine the user to which the current imaging study is to be assigned. For example, the assignment engine 116 compares the current patient of the current imaging study with patients from the patient profiling engine 112 to determined whether the current patient is a cancer patient with repeat follow-up imaging. If so, the image study profiling engine 114 is consulted to determine whether the current study is the next follow-up exam for the current patient. If so, the radiologist who interpreted the patient's most recent study is retrieved from the reader profiling engine 110 and assigned the current imaging study if he/she is available.

In another embodiment, the assignment engine 116 may be implemented with several modules including, for example, an annotation detection module 120, an active user module 122, a net benefit module 124 and an assignment ranking module 126. The annotation detection module 120 consults with the patient profiling engine 112 to determine whether the current study belongs to a patient whose prior studies have been registered using the workflow tool. The active user module 122 tracks which users (e.g., radiologists) are active. For example, the active user module 122 may determine which users have finished a case within a predetermined time period (e.g., past 20 minutes) and/or which users are logged into a clinical workstation. The active user module 122 may also utilize schedule information in digital organizers such as, for example, Microsoft Outlook.

The net benefit module 124 queries the reader profiling engine 110 to determine the prior cases read by all the users (e.g., radiologists) and, for each of the users, computes an expected net gain for using the workflow tool. The net benefit module 124 may use constants that estimate the penalty and gain per lesion in an imaging study. For example, the net benefit module 124 may assign a 6 to 20 second penalty for registering a new lesion and a 3 to 10 second gain for tracking a lesion that has already been registered in the workflow tool. The number of lesions may be used as a variable. If a case has already been annotated with the workflow tool, the number of lesions may be known. Based on this computed expected net gain, the net benefit module 124 may be able to distinguish (i) non-users of the workflow tool, (ii) those who use the workflow tool for pre-registered lesions only, and (iii) those who always use the workflow tool. In a further embodiment, the net benefit module 124 may determine an expected net gain for each anatomy, modality and combination thereof. In an even further embodiment, the net benefit module 124 may use the patient profiling engine 112 to further stratify net gain based on a patient's age, gender, reason for exam and clinical history, which may be determined by analyzing prior clinical documents.

Using the computed expected net gain as a factor, the assignment ranking module 126 ranks users who may read the current imaging study. The assignment ranking module 126 may consider an expected utility gain for the current study along with the expected net gain. For example, if the current study includes a new lesion that would require the lesion to be registered in the workflow tool if read by a user who always uses the workflow tool, the assignment ranking module 126 will recognize that the current imaging study would have the highest expected utility gain if assigned to a non-user of the workflow tool or a user who only uses the workflow tool if the lesion has been pre-registered, since registering the new lesion in the workflow tool would have a penalty associated with it. For a follow-up exam including pre-registered lesions, the user that has the least expected net gain may be ranked the highest while (i.e., highest recommendation for reading the current imaging study) while non-users of the workflow tool may be ranked low (i.e., lowest recommendation for reading the current imaging study). Thus, users that always utilize the workflow tool may be ranked higher than those who only use the workflow tool if the lesions have been pre-registered. The assignment ranking module 126 ensures that imaging studies that are follow-up imaging studies for patients that have already had previous imaging studies registered on the workflow tool will be assigned to users that use the workflow tool so that the current imaging study may be read in the most efficient manner possible.

As an example, consider the situation in which an imaging exam is obtained with 5 lesions. A 6 second penalty is assigned for the registration of a new lesion and a 3 second gain is assigned for the review of a lesion that has already been registered. Assume the case is potentially read by one of three users: A, B or C:
User A is of type (i), i.e., non-user of the tool;
User B is of type (ii), i.e., user on pre-registered lesions only;
User C is of type (iii), i.e., user on all lesions, pre-registered or not.

Suppose that all three users have net benefit 0 when the exam is made and that the exam is interpreted by user C, who registers all 5 lesions. The utility of registering the lesions is 5*−6 =−30 seconds. After finalization of the case, users A and B have net benefit 0, whereas user C has −30. Next, suppose the same patient has a repeat exam. The utility for users B and C is now 5*3=15 seconds, whereas the utility for user A is 0 seconds. Since the net benefit of user C is lower than that of B, and since the utility is 0 for user A, the assignment ranking engine produces the ranking C>B>A, meaning that it prefers that the case be routed to user C, B or A, in this order. If user C is not available for interpretation, the case is routed to user B.

Assignment rankings and/or recommendations may be displayed on the display 106 so that a user may view whether or not an imaging study has been assigned or recommended for him/her. The display 106 may also display expected net benefits for each of the ranked users. The user interface 104 may include, for example, a graphical user interface including the display 106, via which a user may claim the current imaging study, make changes to a status of availability and/or input patient profile information. The user interface 104 may include input devices such as, for example, a keyboard, mouse and/or touch display on the display 106.

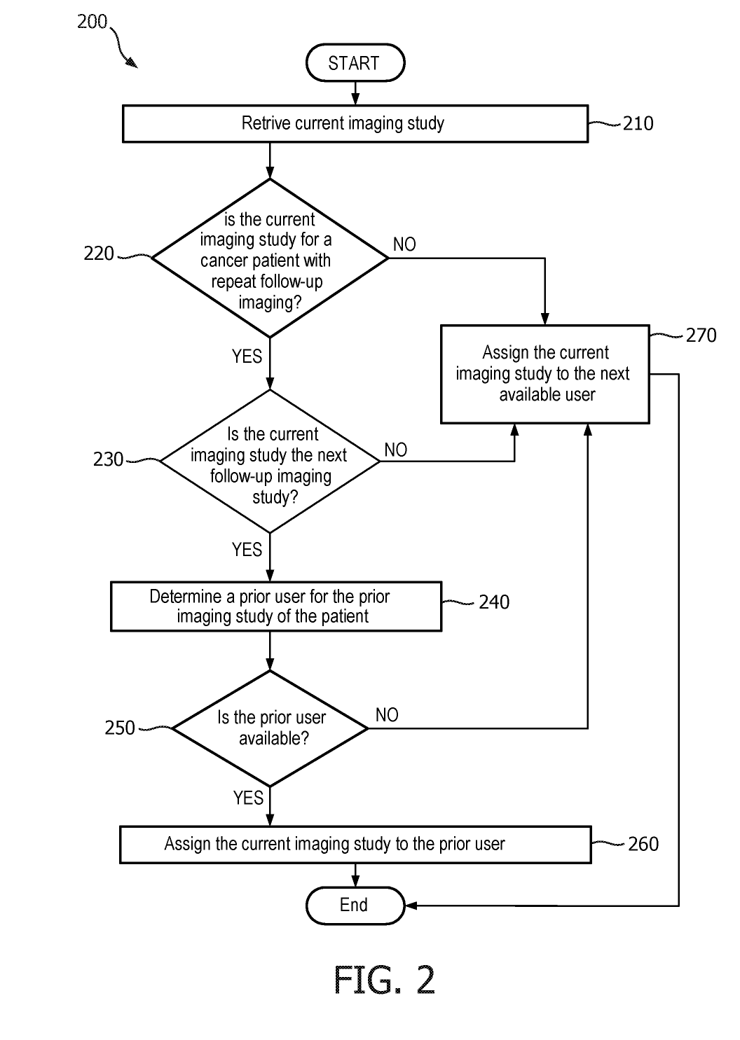

FIG. 2 shows a method 200 for assigning the current imaging study to minimize errors which may result from intra-reader variability. In a step 210, the system 100 retrieves the current imaging study. The current imaging study may be stored and viewed in, for example, a Picture Archiving and Communications System (PACS) within a Radiology Information System (RIS). In a step 220, the patient profiling engine 112 determines whether the current patient of the current study is a cancer patient with repeat follow-up imaging. The assignment engine 116 may, for example, determine intervals between imaging studies, role of referring physician and recurring appointments in the hospital's oncology department to determine whether the current patient is a cancer patient with repeat follow-up imaging.

If the current patient is determined to be a cancer patient with repeat follow-up, the method 200 proceeds to a step 230, in which the image study profiling engine 114 determines whether the current imaging study is the next follow-up imaging study for the current patient. The image study profiling engine 114 may, for example, determine whether a modality and anatomy of the current imaging study matches the modality and anatomy of prior imaging studies of the current patient to identify whether the current imaging study is a follow-up exam. If the current imaging study is determined to be a follow-up exam for the current patient, in a step 240, the reader profiling engine 112 determines the user (e.g., radiologist) that read the prior imaging study of the current patient. As described above regarding the system 100, the reader profiling engine 112 and the patient profiling engine 114 may be used to populate the relational database 118, which stores profile information regarding which readers have read which cases for which patients. Thus, it will be understood by those of skill in the art that the processor 102 may simply consult the database 118 to determine whether the current patient is a cancer patient with repeat follow-ups and who the prior user is.

Once the processor 102 has determined the prior user who read the prior imaging study, the assignment engine 116 determines whether the prior user is available, in a step 250. The assignment engine 116 may determine the availability of the prior user using, for example, the active user module 124, which may determine the availability of a user based on whether the user has recently finished a case and/or whether the user is logged on to a clinical workstation. If the prior user is identified as available, the prior user is assigned the current imaging study, in a step 260. This assignment may be displayed on the display 106. If, however, any of the above conditions in the steps 220, 230 and 250 are not met, the current imaging study may be assigned to the next available user, in a step 270. Alternatively, the current imaging study may be placed in a general queue including all imaging studies requiring reading, so that the current imaging study may be claimed by any one of a number of available users. In particular, if the current study is not for a current patient with repeat follow-up exams, the current imaging study is not a follow-up imaging study and/or the prior user is unavailable, the method 200 may proceed to the step 270 to assign the current imaging study to the next available user or to any user who claims the current imaging study.

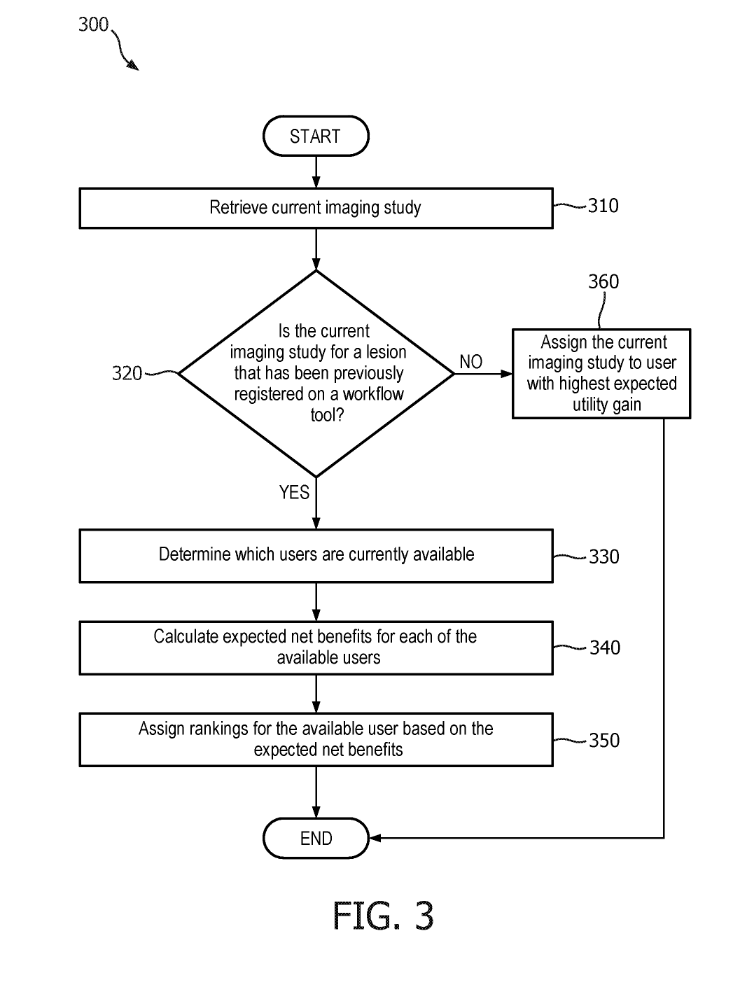

FIG. 3 shows a method 300 for assigning imaging studies in a manner that would permit imaging studies to be read in an efficient manner. For example, follow-up imaging studies that have prior imaging studies that have been registered in a workflow tool may be most efficiently read if assigned to users that use the workflow tool. In a step 310, the system 100 retrieves a current imaging study to be read. As described above in regard to the method 200, the current imaging study may be viewed in, for example, a PACS system. In a step 320, the annotation detection module 120 determines whether the current imaging study is for a current patient whose prior imaging studies have been registered in the workflow tool by, for example, querying the patient profiling engine 112. If, in the step 320 it was determined that the current imaging study is a follow-up imaging study for a cancer patient previously registered in the workflow tool, the method 300 may proceed to a step 330. If the current imaging study, however, is not a follow-up imaging study for a patient whose prior study has already been registered in the workflow tool, the method 300 may proceed to a step 360. In the step 360, the assignment ranking module 126 may assign the current imaging study to the user with the highest expected utility gain. For example, the current imaging study may be assigned to a non-user of the workflow took or a user who only uses the workflow tool when the lesion is pre-registered, as registering the new lesions would have a penalty associated with it. In another embodiment, the current imaging study may be assigned to the next available user. In an alternate embodiment, if the current imaging study is not for a lesion that has been previously registered in the workflow tool, the method 300 may proceed to the steps described above in regard to the method 200, so that the current imaging study may be assigned in a manner that may minimize intra-reader variability, if possible.

In the step 330, the active user module 122 may automatically track which users are active—i.e., available to read the current imaging study. The active user module 122 may determine the availability of each of the users based on factors including, for example, whether the user has recently finished reading an imaging study, whether the user is logged on to a clinical workstation, and whether the user is scheduled to be available. In a step 340, the net benefit module 124 computes the expected net gain, for each of the available users, of using the workflow tool. The net benefit module 124 may, for example, use constants that estimate the penalty and gain per lesion being assessed in the imaging studies. For example, there may be a 6 second penalty for registering a new lesion and a 3 second gain for tracking a lesion that has already been registered in the workflow tool. The number of lesions being assessed may be a variable. For cases that have already been annotated using the workflow tool, however, the number of lesions will be known. The net benefit module 124 may also distinguish non-users of the workflow tool from those users that always use the workflow tool and those users that use the workflow tool when reading a follow-up imaging study in which the prior imaging study has already been registered in the workflow tool by querying the reader profiling engine 110.

In a step 350, the assignment ranking module 126 ranks the available users based on the expected net gain computed in the step 340. For example, the user that has the least expected net gain may be ranked the highest. Non-user of the workflow tool may be ranked the lowest as imaging studies for lesions that have already been registered in the workflow tool may be most efficiently read if read with continued usage of the workflow tool. Thus, the assignment ranking module 126 ranks users based on availability and the expected net gain. If the radiologist with the least expected net gain reads the imaging study, this will increase his/her expected net gain. In this way, continuous application of the method 300 will result in a fair distribution of penalty and gain among radiologists. In another embodiment, the assignment engine 114 may automatically assign the current imaging study to the available user with the least expected net gain. This assignment ranking may be displayed on the display 106 using, for example, a graphical user interface. The graphical user interface may permit users to claim or decline imaging studies for which they are ranked. The expected net benefit for each of the ranked users may also be displayed on the display 106.

In further embodiments, the user interface 104 may be utilized to input preferences for the method 300. In one embodiment, it may be preferred to lock or hide cases for certain groups of users. For example, non-users of the workflow tool may be locked or prevented from being ranked via the assignment ranking module 126. In another example, a user may set a predetermined time period during which the current imaging study must be read by one of the ranked users. If the current imaging study is not read within this predetermined time period, the current imaging study may be made available to more users or may be automatically assigned to the next available user.

It is noted that the claims may include referenced signs/numerals in accordance with PCT Rule 6.2(b). However, the present claims should not be considered to be limited to the exemplary embodiments corresponding to the reference signs/numerals.

Those skilled in the art will understand that the above-described exemplary embodiments may be implemented in any number of manners, including, as a separate software module, as a combination of hardware and software, etc. For example, the reader profiling engine 110, the patient profiling engine 112, the image study profiling engine 114, the assignment engine 116, the annotation detection module 120, the active user module 122, the net benefit module 124 and the assignment ranking module 126 may be programs containing lines of code that, when compiled, may be executed on a processor.

It will be apparent to those skilled in the art that various modifications may be made to the disclosed exemplary embodiments and methods and alternatives without departing from the spirit or scope of the disclosure. Thus, it is intended that the present disclosure cover the modifications and variations provided that they come within the scope of the appended claims and their equivalents.

1. A method for efficiently assigning an imaging study to be read, comprising:
retrieving a current imaging study to be read;
determining whether the current imaging study is for a patient whose lesion has been previously registered in a workflow tool; and
assigning the current imaging study to a user based on at least one of a computed expected net gain for each user available to read the current imaging study and an expected utility gain for the current imaging study, the expected net gain based on whether each user utilizes the workflow tool.

2. The method of claim 1, further comprising:
ranking each user available to read the current imaging study based on the at least expected utility gain and the expected net gain.

3. The method of claim 1, further comprising:
assigning the current imaging study to a user having the lowest expected net gain.

4. The method of claim 1, wherein if the current imaging study is not for a patient whose lesion has been previously registered in the workflow tool, the method further comprising:
determining whether the current imaging study is a follow-up to a prior imaging study;
determining whether a user who read the prior imaging study is available to read the current imaging study; and
assigning the current imaging study to the user who read the prior imaging study, if available.

5. The method of claim 4, wherein determining whether the current imaging study is a follow-up to a prior imaging study includes:
identifying a modality and an anatomy of the current imaging study; and
matching the identified modality and anatomy to a modality and anatomy of the prior imaging study.

6. The method of claim 1, further comprising:
storing a profile of each user to a database, the profile for each user including information regarding all prior imaging studies read by each users.

7. The method of claim 6, further comprising:
storing to the database a profile for each patient, the profile for each user including information regarding prior imaging studies for each patient.

8. The method of claim 1, wherein the expected net gain is computed using constants that estimate a penalty and a gain for each lesion imaged by the current imaging study.

9. The method of claim 1, wherein an availability of each user is determine via one of (i) whether the user has finished reading a case within a predetermined period of time; (ii) whether the user is logged on to a clinical workstation; and (iii) whether the user is indicated as available in schedule information of a digital organizer.

10. The method of claim 1, wherein the workflow tool is a system in which meta-data is added to an imaging study.

11. A system for efficiently assigning an imaging study to be read, comprising:
a non-transitory computer readable storage medium storing an executable program; and
a processor executing the executable program to cause the processor to:
retrieve a current imaging study to be read;
determine whether the current imaging study is for a patient whose lesion has been previously registered in a workflow tool; and
assign the current imaging study to a user based on at least one of a computed expected net gain for each user available to read the current imaging study and an expected utility gain for the current imaging study, the expected net gain based on whether each user utilizes the workflow tool.

12. The system of claim 11, wherein the processor executes the executable program to cause the processor to rank each user available to read the current imaging study based on the expected net gain.

13. The system of claim 12, further comprising a display displaying rankings of each user available to read the current imaging study.

14. The system of claim 11, wherein the wherein the processor executes the executable program to cause the processor to assign the current imaging study to a user having the lowest expected net gain.

15. The system of claim 11, wherein if the current imaging study is not for a patient whose lesion has been previously registered in the workflow tool, the processor executes the executable program to cause the processor to:
determine whether the current imaging study is a follow-up to a prior imaging study;
determine whether a user who read the prior imaging study is available to read the current imaging study; and
assign the current imaging study to the user who read the prior imaging study, if the user who read the prior imaging study is available.

16. The system of claim 15, wherein the processor executes the executable program to cause the processor to identify a modality and an anatomy of the current imaging study and match the identified modality and anatomy to a modality and anatomy of the prior imaging study to determine whether the current imaging study is a follow-up to a prior imaging study includes.

17. The system of claim 11, further comprising a database storing profiles for all users, a profile for each of the users including information regarding all prior imaging studies read by each user and profiles for all patients, a profile of each of the patients including information regarding all imaging studies of each patient.

18. The system of claim 11, wherein the processor executes the executable program to cause the processor to compute the expected net gain using constants that estimate a penalty and a gain for each lesion imaged by the current imaging study.

19. The system of claim 11, wherein the processor executes the executable program to cause the processor to determine an availability of each user via one of (i) whether the user has finished reading a case within a predetermined period of time; (ii) whether the user is logged on to a clinical workstation; and (iii) whether the user is indicated as available in schedule information of a digital organizer.

20. The system of claim 11, wherein the workflow tool is a notation system in which meta-data is added to an imaging study.

21. A non-transitory computer-readable storage medium including a set of instructions executable by a processor, the set of instructions, when executed by the processor, causing the processor to perform operations, comprising:
retrieving a current imaging study to be read;
determining whether the current imaging study is for a patient whose lesion has been previously registered in a workflow tool; and
assigning the current imaging study to a user based on at least one of a computed expected net gain for each user available to read the current imaging study and an expected utility gain for the current imaging study, the expected net gain based on whether each user utilizes the workflow tool.
